(19) United States
(12) Patent Application Publication
(10) Pub. No.: US 2014/0372167 A1
(43) Pub. Date: Dec. 18, 2014

(54) System and Method for Providing a Capacity Reservation System for a Virtual or Cloud Computing Environment

(71) Applicant: CiRBA Inc., Richmond Hill (CA)

(72) Inventor: Andrew D. HILLIER, Toronto (CA)

(21) Appl. No.: 14/472,001

(22) Filed: Aug. 28, 2014

Related U.S. Application Data
(63) Continuation of application No. PCT/CA2013/050157, filed on Mar. 1, 2013.
(60) Provisional application No. 61/605,559, filed on Mar. 1, 2012.

(51) Int. Cl. G06Q 10/06

(52) U.S. Cl. CPC G06Q 10/06314; G06Q 10/067
USPC 705/7.24

(57) ABSTRACT

A system and method are provided for determining workload reservations in a virtual or cloud computing environment, the method comprising: determining a workload to be booked and a time for which the booking is to be placed in the environment; modeling a future demand in the environment; modeling a future supply of hosts in the environment based on data obtained from the environment; executing a placement analysis using a future demand model, a future supply model, and at least one policy indicative of parameters of the placement; and using a result of the placement analysis in completing or rejecting a booking for the workload.

### CROSS-REFERENCE TO RELATED APPLICATIONS

This application is a continuation of PCT Application No. PCT/CA2013/050157 filed on Mar. 1, 2013 which claims priority from U.S. Provisional Application No. 61/605,559 filed on Mar. 1, 2012, both incorporated herein by reference.

### TECHNICAL FIELD

The following relates to systems and methods for providing a capacity reservation system for a virtual or cloud computing environment.

The management of computing resources within an organization can be a complex endeavor. Since demands on the computing resources can change, computing environments often need to keep spare capacity (supply) on hand to accommodate these changing demands. In closed environments, with relatively static demands, the management of supply and demand is feasible even if not efficient or completely cost effective. However, with the rise of cloud computing and next-generation virtual platforms, demand becomes much more dynamic, and the management of computing supply and demand becomes more difficult. When managed with more sophisticated and predictive analytics, however, these new computing models also provide the ability to become more efficient and cost effective.

A problem with cloud computing or other virtual computing environments is that a solution is lacking for managing supply and demand.

### SUMMARY

There is provided a method determining workload reservations in a virtual or cloud environment, the method comprising: determining a workload to be booked and a time for the booking; modeling a future demand in the environment; modeling a future supply of hosts in the environment based on at least one of data obtained from the environment and planned changes to the environment; executing a placement analysis using a future demand model, a future supply model, and at least one policy; and using a result of the placement analysis in completing or rejecting a booking for the workload.

There are also provided a computer readable medium with instructions for performing the method, and system configured to perform the method.

### BRIEF DESCRIPTION OF THE DRAWINGS

Embodiments will now be described by way of example only with reference to the \appended drawings wherein:

FIG. 1 is an example of a public cloud computing environment including a capacity reservation system;

FIG. 2 is an example of a private cloud computing environment including a capacity reservation system;

FIG. 3 is an example of a typical cloud computing ecosystem;

FIG. 4 is an example of the inclusion of a capacity reservation system in the ecosystem of FIG. 3;

FIG. 5 is a block diagram of an example of a configuration for a capacity reservation system;

FIG. 6 is a flow chart illustrating computer executable operations that may be performed in executing a capacity reservation process;

FIG. 7 is a flow diagram illustrating an example application of predictive analytics in executing a capacity reservation process;

FIG. 8 is a pictorial diagram illustrating a predictive placement analogy;

FIG. 9 is a flow chart illustrating computer executable operations that may be performed in modeling workloads for a capacity reservation process;

FIG. 10 is a flow chart illustrating computer executable operations that may be performed in executing a cloud factory analysis;

FIG. 11 is a chart illustrating an example comparison of policy areas across different types of cloud hosting environments;

FIG. 12 is a flow chart illustrating computer executable operations that may be performed in executing a capacity reservation process in a cloud computing environment;

FIG. 13 is an example of a user interface for visualizing an efficiency index for an illustrative set of virtual clusters based on policies specific to each cluster;

FIG. 14 is an example of a user interface for providing a bookings view illustrating new applications due to come online and new servers being added; and

FIG. 15 is an example of a user interface for visualizing a predictive analysis for the virtual clusters shown in FIG. 13.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles. Also, the terms “booking” and “reservation” are used synonymously, as both refer to the act of confirming that something will fit and putting a lock on the resources to ensure the request can be fulfilled.

It can be recognized that most environments involving the use of shared assets or resources rely on a reservation system to manage the booking of these resources. For example, hotels, airlines, rental companies, and restaurants rely on reservation systems to ensure the optimization of the use of their resources over time in a way that balances customer satisfaction and profitability. In other words, reservation systems are used to ensure the future balance supply and demand in a particular environment.

While many environments rely on reservation systems, it has also been recognized that modern information technology (IT) environments are lacking when it comes to having a functioning reservation system. Although the evolution of IT hosting models, and the fact that the closed nature of physical and early virtual environments made it possible to survive without a reservation system, the rise of cloud computing has made this survival tenuous, since the consumerization of capacity is making the modeling future bookings and proper forecasting of demand important to operating IT environments.

To explore the notion of a reservation system for virtual and cloud environments, an analogy can be made to human living arrangements. For many years, applications were directly hosted on physical servers, and hosting models were relatively inflexible. This is directly analogous to living in a house, where a large capital outlay provides one a place to live for a long time, and as long as the house is maintained.

With the popularization of virtualization in recent years, the model shifted to more closely resemble living in an apartment. Sharing common resources provides economies of scale, and capital expenditure can be shifted to be more operational (i.e. monthly rent). And, like apartments, moving in and out typically happens more frequently than in houses, but it is still not frictionless, and requires movers and careful planning. This, combined with the legal and contractual obligations (lease agreements), tends to cause people to stay for a while, and tenancy is typically fairly long. The analogy also applies to mainframe environments, which have been virtual for some time, but also have a relatively non-volatile tenancy model.

It has been observed using this example that neither houses nor apartment buildings require reservation systems to manage supply and demand. Houses are not commonly shared, and apartments become vacant and are filled again with such low frequency that it is possible for building managers to deal with in a relatively simple way. Unfortunately, the same is not true for cloud environments. Cloud environments more closely resemble hotels than houses or apartments, as there are few barriers to coming and going, and capacity can be used for whatever amount of time is desired. Furthermore, hosting internal clouds on converged infrastructure, where large blocks of capacity are typically deployed at once, is a lot like managing a very large hotel, with a “revolving door” of new customer demands to deal with. With the scale and dynamic nature of these environments, properly matching guests to rooms over time is a tremendous challenge, particularly with mass onboarding of customers for conferences, weddings, etc.. Consequently, hotels require reservation systems to carefully manage supply and demand.

Unfortunately many IT organizations do not have a reservation system. The trend towards an internal cloud is directly analogous to shifting from apartments to hotels, but management systems have not been keeping up. Compounding this, adopting one of the many emerging cloud stacks to deal with this may only make it worse, as that breed of solution invariably focuses on enabling immediate requests, not future bookings, and they typically have no ability to model future demands and do the appropriate forecasting. Because of this, infrastructure teams are left to wildly over-provision capacity in hopes they will have enough to offset any potential future demand, eroding the potential savings and efficiency associated with operating shared infrastructure in the first place. If they under-estimate then the consequences are equally damaging, resulting in performance and Service Level Agreement (SLA) compliance issues, or an inability to fulfill the business's requirements. The fact that IT environments have survived without a reservation system can be justified given its evolution, however, since many organizations are pursuing virtual and cloud solutions, a capacity reservation system such as that described herein is important in managing supply and demand in such virtual and cloud environments.

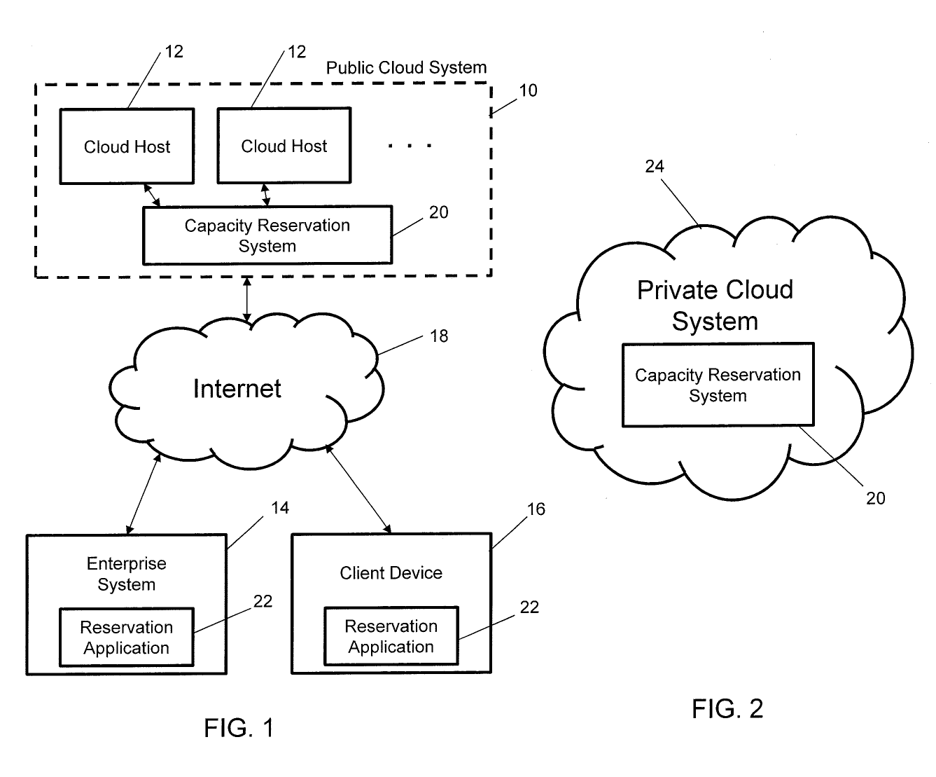

Turning now to FIG. 1, an example of a public cloud system 10 is shown, which includes a number of cloud hosts 12. The cloud host 12 may include any computing asset or resource that is used to accommodate a computing workload, e.g. processing, storage, etc. In the example shown in FIG. 1, an enterprise system 14 and a client device 16 are shown as example “customers” using the public cloud system 10 for computing resources. The enterprise system 14 and the client device 16 are illustrated as communicating with the public cloud system 10 via the internet 18, however, it can be appreciated that a plurality of networks may be traversed in communicating with the public cloud system 10. For example, the client device 16 may access the internet 18 via a cellular network. The public cloud system 10 includes or otherwise has access to a capacity reservation system 20 for managing the supply and demand of the public cloud system 10. The enterprise system 14 and client device 16 may utilize a reservation application 22 in order to communicate with the capacity reservation system 20 to create “bookings” or otherwise use the public cloud system 10.

FIG. 2 illustrates a private cloud system 24 hosting a capacity reservation system 20. The private cloud system 24 may be a closed network operated by an organization with the capacity reservation system 20 being deployed to manage the supply and demand of workloads within the organization's own environment. Therefore, it can be appreciated that the capacity reservation system 20 may be deployed in any environment in which the management of supply and demand of computing resources or assets is beneficial, including other types of virtual, distributed, or networked environments.

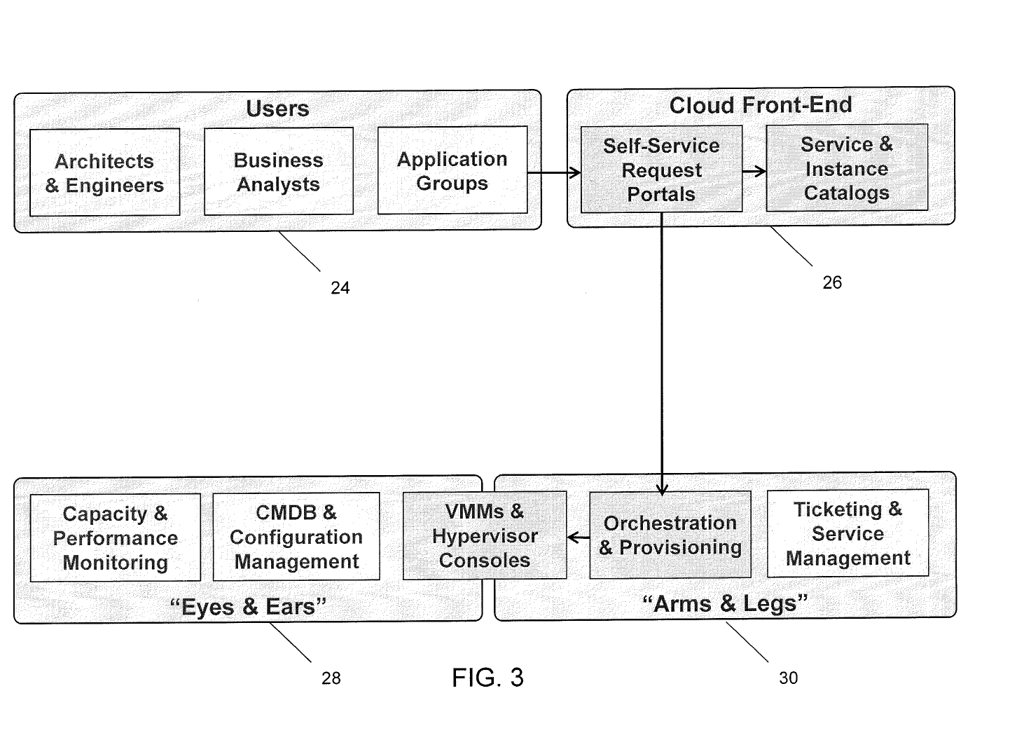

FIG. 3 illustrates a typical cloud computing environment 10, 24, in which users 24 (e.g., architects, engineers, business analysts, application groups, etc.) interact with the systems that provision and manage computing resources 30 (the “arms and legs”) via a cloud front-end 26. The cloud front-end 26 includes self-service request portals for enabling users to provision new workloads and applications based on various service and instance catalogs, which describe what capacity and software is on offer. The computing resources 30 include orchestration and provisioning systems, which tend to be highly automated, as well as ticketing and service management systems for managing manual activities and controlling changes in critical environments. The orchestration and provisioning may interact with VMMs and hypervisor consoles to enact specific actions (e.g. start or stop a VM, move a virtual machine from one host to another). The monitoring systems 28 (the “eyes and ears”) are the part of the ecosystem that evaluate and monitor the computing resources 30 from an operational perspective. In the example shown in FIG. 3, the monitoring system 28 includes capacity and performance monitoring, CMDBs, configuration management systems and virtual machine managers (which often have the dual function of providing monitoring data as well as enacting provisioning and orchestration requests).

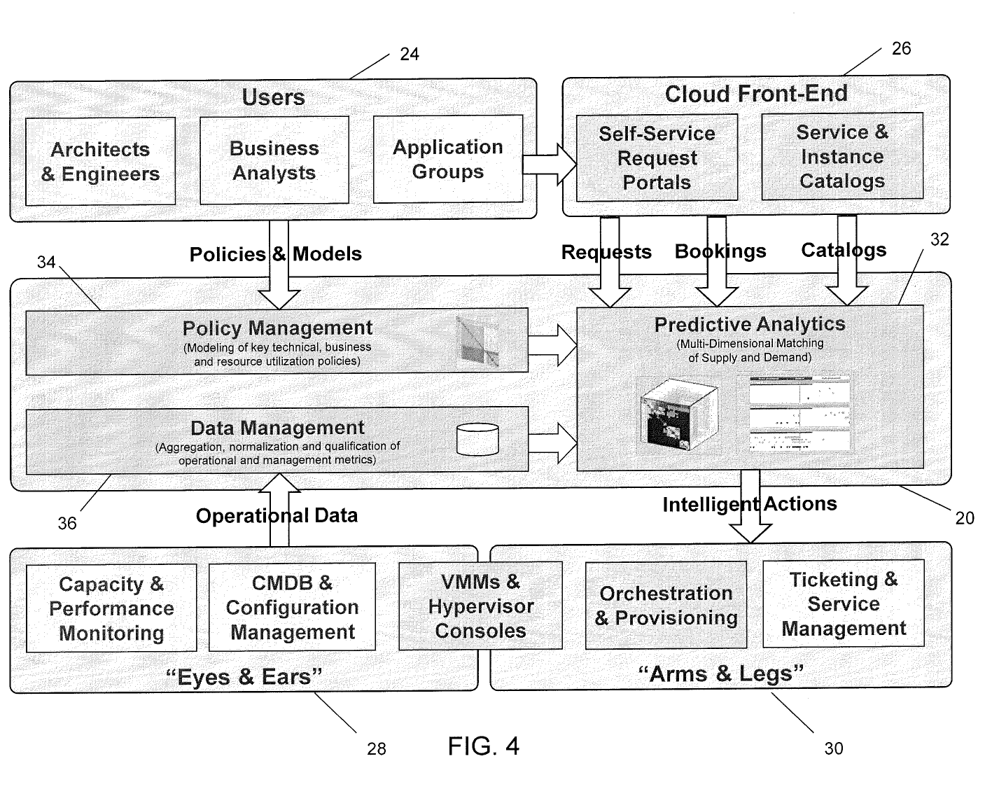

FIG. 4 illustrates the inclusion of the capacity reservation system 20 between the users 24 and the cloud front-end 26 and the computing resources 30 and monitoring system 28. The capacity reservation system 20 configured in this way can execute policy management 34 by obtaining policies and models and data management 36 by obtaining operational data from the monitoring system 28. The cloud front-end 26 can be used to gather immediate requests or future bookings, and evaluate these using a predictive analytics model 32 that utilizes policy management 34 and data management 36 to generate intelligent actions for the computing resources 30.

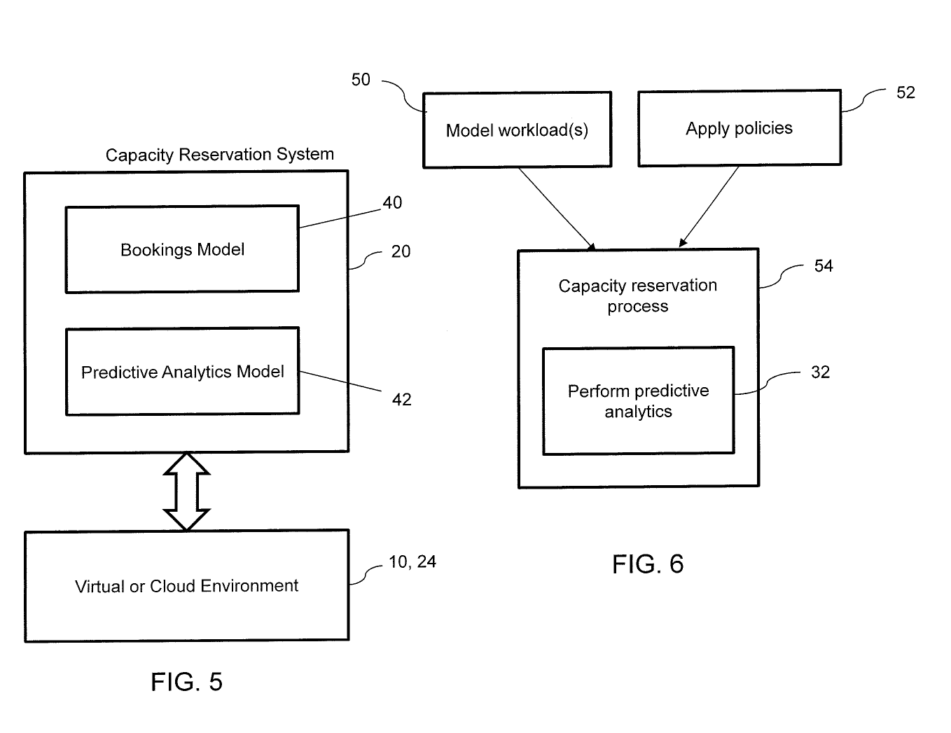

The capacity reservation system 20 enables workloads to be predictively booked in environments such as virtual and cloud environments 10, 24 where resources are overcommitted or otherwise shared. The capacity reservation system 20 accomplishes this by performing predictive placement analyses to commit new bookings while considering policies and previously booked but not yet deployed workloads. Turning now to FIG. 5, the capacity reservation system 20 includes a bookings model 40 and a predictive analytics model 42 , which are applied to a virtual or cloud environment 10, 24 to perform the predictive analytics 32 as illustrated in FIG. 4.

A method for implementing a capacity reservation process 54 is shown in FIG. 6. It has been recognized that in order to implement such a capacity reservation process 54, workloads 70 that are to be placed on cloud hosts 12 should be modeled based on the bookings and trends related to the workloads 70. In addition to modeling the workloads 70, policies should be applied in order to define the parameters that drive the predictive analytics 32 and determine whether or not the workloads 70 can be placed, where they can be placed, and any other constraints or criteria required to enable the workloads 70 to be implemented. The predictive analytics 32 enables the capacity reservation system 20 to not only determine where things fit, but also to commit resources to the bookings to ensure that subsequent bookings take previous bookings into account, even when they are set to come online in the future.

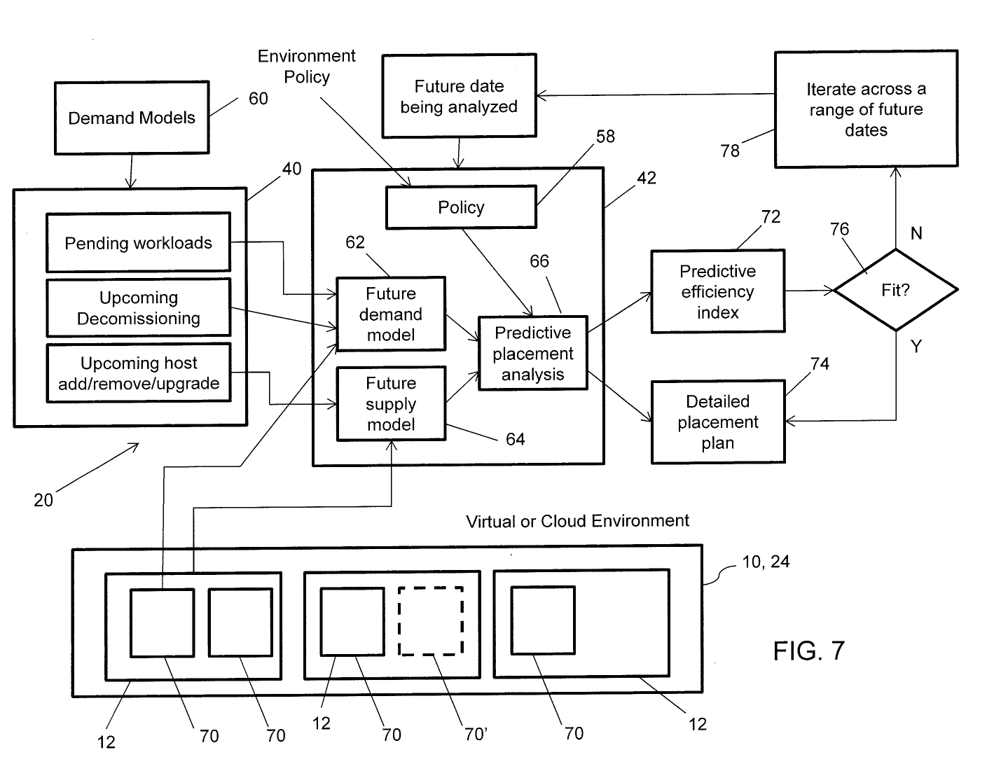

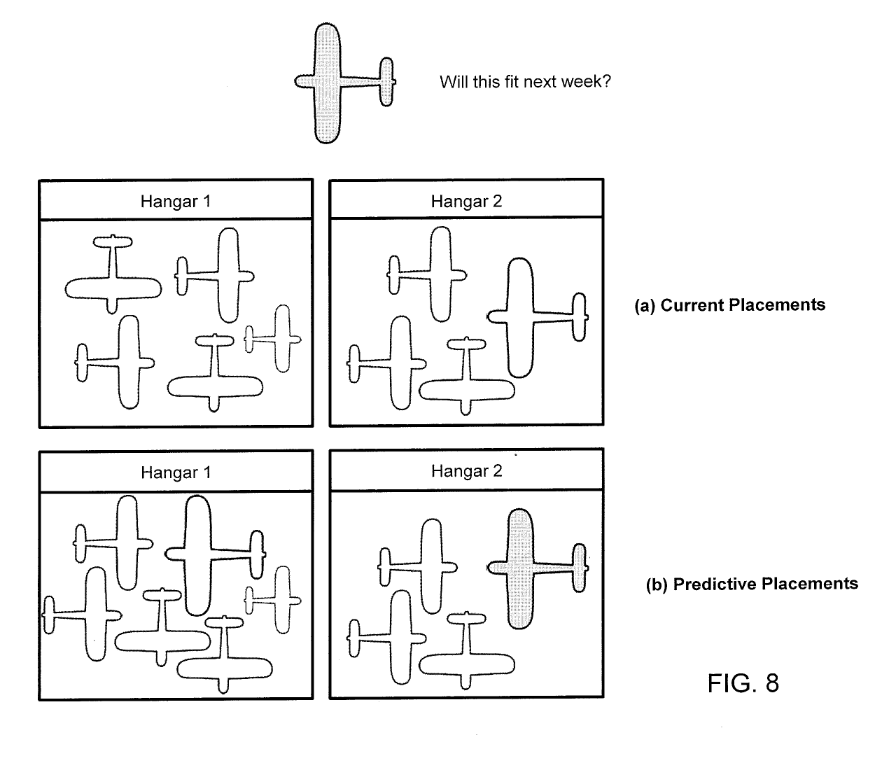

Turning now to FIG. 7, a flow diagram is shown to illustrate an implementation of the bookings model 40 and predictive analytics model 42 to generate a detailed placement plan 74. The bookings model 40 is a time-based representation of the future inflow and outflow of both supply and demand. On the demand side the bookings model 40 models the resource demands that will be placed on the environment, both in terms of resource allocations (e.g. how many CPUs are required, how much memory should be allocated) and actual/anticipated resource utilization (time-series utilization patterns). It also specifies the specific date and time it will enter the environment. These demand models 60 are fed by several external sources, including bulk onboarding (factory analysis), new application deployment (release management) and cloud self-service requests. Outbound demand (decommissioning) is modeled by associating an end date to an existing workload.

On the supply side the bookings model 40 represents new capacity entering the environment at a future date (using server models with specific resource specifications) or servers being temporarily or permanently removed from an environment (modeled by associating an end date with an existing server). For example, as shown in FIG. 7, pending workloads, upcoming decommissioning, and upcoming host add/remove/upgrade events may be considered in feeding data to the predictive analytics model 42.

The predictive analysis model 42 combines data from the bookings model 40 with data from the actual running environment 10, 24 to build a complete forward-looking model of both supply 64 and demand 62. This is specific to a future point in time, and the analysis model 42 can analyze multiple future scenarios by using different target dates by iterating 78 across a range of future dates. Workload trends are applied to existing workloads to ensure that the growth (or shrinkage) of existing workloads is properly represented in the model.

The predictive supply and demand data is then analyzed using predictive placement analysis 66, which uses multi-dimensional optimization criteria in order to determine the exact placements and allocations for each demand (workload 70) onto each element of supply (host 12). This analysis 66 is guided by detailed policies 58 that govern the qualitative and quantitative preferences and constraints on a given environment 10, 24, and these policies 58 may be different for each environment 10, 24.

The resulting predictive placement plan 74 is important in reserving capacity, as it is typically not possible to definitively determine whether a set of workloads 70 will fit into an environment without considering the complete set of future supply and demand, and how these demands will “fit together” in the available capacity. Because utilization patterns are a key component of this, it is often necessary to move existing workloads 70 around to free up contiguous capacity for new requests. When a “defrag” algorithm is used to optimize future density, then the analysis 66 will generate an efficiency index 72, which is a numeric representation of how full an environment 10, 24 is or will be. As exemplified below, the efficiency index 72 may be used as a gauge of how relatively under or over capacity an environment 10, 24 is and can include any suitable scale. For example, in the examples provided below, if the efficiency index 72 is less than or equal to 1.0 then this indicates that the requested bookings can be fulfilled without saturating the environment 10, 24. If the efficiency index exceeds 1.0 then this indicates that the requested bookings will saturate the capacity at the future point in time being analyzed, indicating that the booking cannot be honored. To that extent, as illustrated in FIG. 7, the efficiency index 72 may be used to determine at 76 if the booking will fit. The process may iterate across a range of future dates such that several dates can be evaluated to get a more complete picture and provide greater assurance. For example, 30, 60 and 90 days into the future can be evaluated, as well as every day for the next 7 days to get a “high resolution” picture of the short term capacity forecast.

Because any new bookings will be evaluated against both existing workloads 70 as well as previously requested bookings 70′, this effectively locks the capacity for those previous requests, ensuring the booking can be honoured on the booking date. The incumbency of previous requests causes them to take precedence over new requests (even if those requests are for an earlier date in the future). Also, iterating against a range or discrete set of future dates at 78 allows complex inbound and outbound booking activity to be fully evaluated, and also enables a complete capacity forecast to be generated (effectively a time series set of future efficiency indices 72).

Although an analogy to hotel reservation systems was given previously, the act of reserving capacity in virtual or cloud environments is much more challenging, as they typically share resources and use what is referred to as “overcommit”. Overcommit is the act of allocating out more “virtual” resources than there are “physical” resources in an environment, and leverages the fact that not all workloads are using all resources all the time. In other words, the “shapes and sizes” of the workloads matter more than how much resources they have been allocated (as opposed to a hotel, where an entire room is allocated and is not shared). To further illustrate this effect in the capacity reservation process 54, an analogy of booking space for aircraft in a set of aircraft hangars will now be provided. As shown in FIG. 8, a new booking may be represented by a new aircraft. The task is to determine if the new aircraft will fit in either Hangar 1 or Hangar 2 next week so the space can be booked for the aircraft owner. Stage (a) corresponds to the current placements, wherein five aircraft are parked in Hangar 1 and four in Hangar 2. As currently configured, it is not clear whether the demand for new space can be met. The “over commitment” of capacity (squeezing the aircraft together so they overlap with each other) means that it is not possible to confirm the booking without carefully analyzing the shapes and sizes of existing aircraft (as well as which ones are leaving in the next week). Similarly, in a virtual or cloud environment 10, 24, resources are typically over committed since many workloads do not run at the same time, resources can be shared, and workloads can be shifted around or overlap each other.

In stage (b), by optimizing placements based on the aircraft shape and size shows that the new aircraft can be accommodated through the rebalancing of existing aircraft, and therefore hangar space can be booked. A similar accommodation can be made by determining when particular aircraft are leaving and if new aircraft already booked to arrive are larger or smaller or configured such that the new booking can be accommodated. It can be appreciated that a solution to this problem cannot be arrived at by simply considering the square footage of the hangars and planes, and allocating out rectangular areas of floor space (as a hotel does) would be wildly inefficient. The fact that booking space is not possible without first determining whether there exists a set of placements that would make everything fit is a key concept, and is fundamental to booking capacity in virtual and cloud environments.

### Demand Modeling

As discussed above, there are two main influences on data center demand, namely trends and bookings. Trends refer to the growth (or shrinkage) in demand caused by natural shifts in user activity, organic growth, and business-led changes, such as M&A activity or marketing campaigns, that impact existing IT applications. Bookings are the new demands that are entering (or leaving) the cloud environment 10, 24 which are related to new application deployment, bulk on-boarding activity (such as physical to virtual migrations or data center consolidation), or other project-based activity. Both bookings and trends are important to forecasting capacity requirements, but require different modeling approaches.

Most IT organizations have traditionally been able to trend demand growth, but often lack the tools required to model future capacity bookings, virtual and cloud on-boarding, decommissioning and supply-side changes (such as the addition of new servers or technology refresh), etc. This inability can be troublesome because like hotels, the impact of individual demand trends 30 is often dwarfed by the impact of new workloads 70 coming online (and old ones leaving), particularly in cloud environments 10, 24.

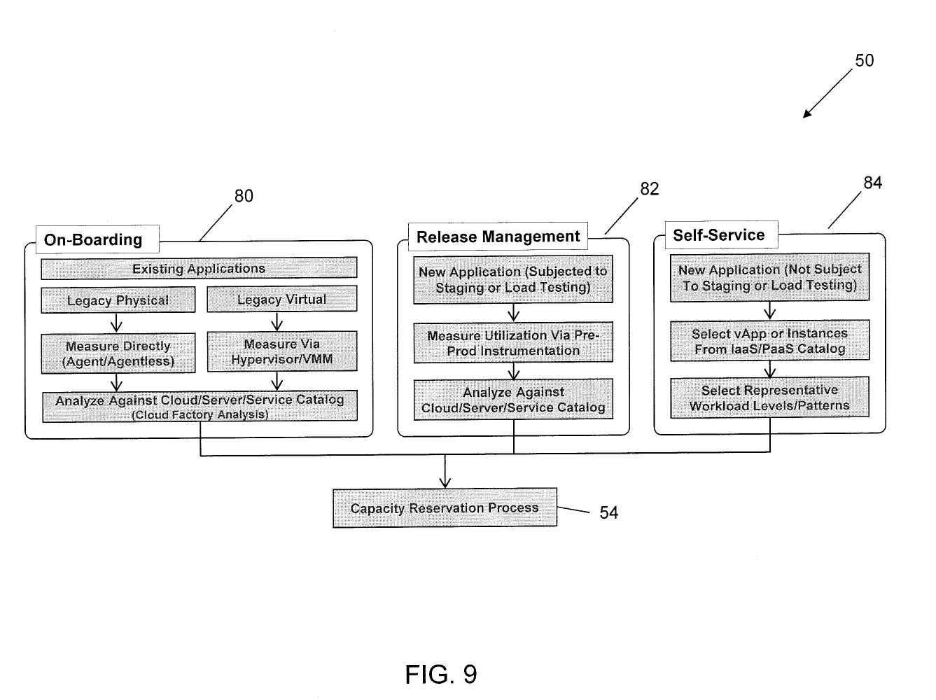

FIG. 9 illustrates three sources of demand in virtual and cloud environments 10, 24, namely bulk on-boarding 80 of existing applications, the planned release of new applications through standard IT service delivery processes (release management 82), and self-service 84 requests emanating from cloud users. On-boarding 60, release management 82, and self-service 84 demand sources require the capacity to be reserved in the target environment 10, 24, in order to guarantee the fulfillment of their needs, but each has a different way of defining this requirement.

As illustrated in FIG. 9, bulk on-boarding 80 typically occurs when migration, conversion or consolidation projects move existing applications from legacy infrastructure into virtual or cloud environments. This includes physical-to-virtual and physical-to-cloud migrations, as well as virtual-to-cloud migrations, where early adopters of virtualization sunset older environments and move to the next generation of hosting platform. It also includes data center consolidation activity, particularly when it combines facilities migrations with new hosting models, where “waves” of servers are moved into new locations and placed on new virtual or cloud infrastructure as part of the process.

Regardless of the source of the new demand, the demand will need to be characterized. This involves either direct measurement of the server activity (via agents or agentless means), acquiring data from hypervisors or virtual machine managers (in the case of virtual workloads), or leveraging data from existing capacity management or performance monitoring systems (if they have sufficient coverage). Some level of configuration information may also be required, such as processor counts and configurations, installed software details, identification of load balancing groups, etc. This data and configuration information is needed to understand the workload levels and patterns, as well as the software requirements, so they can be accurately mapped to the cloud capacity models and software configurations (e.g., as defined in a cloud catalog, which is described in greater detail below).

Most new applications, particularly those that are “mission critical” in nature, follow prescribed IT service delivery processes in order to make their way into production. The release of such applications is typically well planned, and on their journey to production they pass through a series of pre-production environments for testing, acceptance and staging. The opportunity in cloud environments 10, 24 is to use these steps to gain an understanding of the anticipated demands on IT infrastructure, and to use this to accurately map the requirements into the eventual production environments they will be hosted in. This is a win-win scenario, as the use of cloud infrastructure not only reduces the lead time required to deploy an application (by eliminating hardware procurement from the critical path), but also allows for very precise sizing of the target environment 10, 24 it will run in.

If realistic load testing is not part of the release management process 82, then virtualization and cloud hosting models also enable other ways to gauge demand. For example, over-provisioned “soaking pools” can be used as part of the release management process 82 to host new applications in order to determine their utilization patterns (using actual production workloads). After the measurements converge (typically by observing an entire business cycle) the application can be accurately sized and moved to a more permanent home. This also allows applications to be routed to the appropriate type of capacity, such as Storage Area Network (SAN) vs. Network Attached Storage (NAS)-based storage or highly threaded vs. “big core” processors.

An emerging aspect of cloud technologies is the ability for end-users to request capacity themselves, rather than to always use IT groups as the intermediary, i.e. a self-service process 84. This may be done as part of a release management process 82, but more often it is used to support more agile demands, where standard OS builds and software stacks are pieced together to rapidly build new applications or augment existing ones. In these cases, there is typically no legacy or pre-production that can be used to measure application demand levels or patterns, and it is left to the users to estimate what infrastructure is needed.

The estimation of what infrastructure is needed may be done by selecting cloud instance sizes from a catalog and, if supported by the cloud technology, also selecting a “representative workload” to provide a model of the target utilization. Such a process can be difficult, either because the end users do not know what their demands will be, or they know what they will be but do not know how to translate their needs into the language of “Gigahertz and Gigabytes” typically used within an IT infrastructure. Users also have a tendency to ask for too much, even if their demands are well known. Clouds that support a significant number of self-service requests often require “resource reclamation” processes that kick in during steady-state operation in order to correct over-provisioning of guest instances, and can even be passed through the complete “soaking pool” approach described previously.

### Cloud Factory Analysis

With the demand profiles having been characterized through either measurement or estimation, the demand profiles are analyzed against supply-side capacity models offered by the cloud technology being used. This is not required for self-service 84 requests, where the users enter their requirements in terms of the cloud catalog in the first place, but is important to the on-boarding 80 and release management 82 processes.

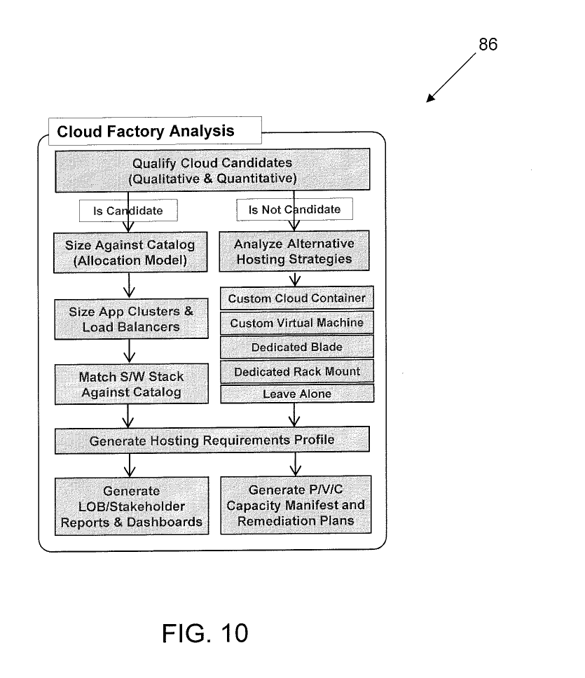

A cloud factory analysis 86, an example of which is shown in FIG. 10, should be scalable and repeatable, and should use both quantitative and qualitative analyses in order to answer the following questions:

Which systems are candidates to host in the cloud 10, 24?

Of these candidates, what instance sizes and software stacks do they map to?

If the candidates are not identical to the models on offer, what remediation steps are needed?

How should load balancers and application clusters be sized?

For systems that are not candidates for the cloud system 10, 24, what is the optimal alternative hosting model?

By answering these questions, a complete model of new demands can be constructed, that includes not only the anticipated utilization levels, but also the cloud resource allocation requirements and instance configuration details. All of this can be input into the capacity reservation process 54, where the confirmation of available capacity includes both resource utilization as well as allocation limitations.

### Policies

Policies 58 are becoming increasingly important in the management of shared infrastructure, as they effectively form the contract between supply and demand. By accurately capturing, formalizing and managing to a specific set of business and operational criteria for a specific hosting environment, users can confidently let go of legacy infrastructure knowing that specific needs will be met and rights will not be violated.

The detailed policies 58 that govern the operation of cloud environments 10, 24 may be referred to as “cloud control” policies 58. Properly-specified cloud control policies 58 cover both quantitative and qualitative criteria, allowing the policies 58 to represent detailed operational, technical and business requirements. Quantitative criteria include such things as maximum and minimum utilization levels, resource overcommit targets, contention tolerances, and other operational considerations. Qualitative criteria include business rules, technical affinities and anti-affinities, security requirements, process-oriented requirements, etc.. Because these factors may vary from environment to environment (e.g. production vs development/testing) it is common to have several policies 58 active in a given organization, creating pools of capacity that are designed to meet specific application requirements.

The use of policies 58 is important to the capacity booking process 54, as the ability to place a new demand (e.g., workload 70) into a specific environment 10, 24 is governed by the policy 58 that is being used to manage it, and the point at which an environment 10, 24 is deemed to be full is a function of supply, demand, trends, bookings and policies 58. Understanding the policies 58 that apply to new workloads 70 coming into an environment 10, 24 is therefore important to the capacity forecasting process, as it dictates into which environments 10, 24 the workload 70 can go, whether or not the workload 70 will fit, and how much capacity the workload 70 truly require, which often forms the basis for reserving capacity. Policies can also model “gating” criteria, which may cause a booking to be rejected for non-capacity reasons. An example of this would be a data sensitivity policy that dictates that customer data must reside within an organization, causing bookings requests to external clouds to be rejected if the workloads require such data.

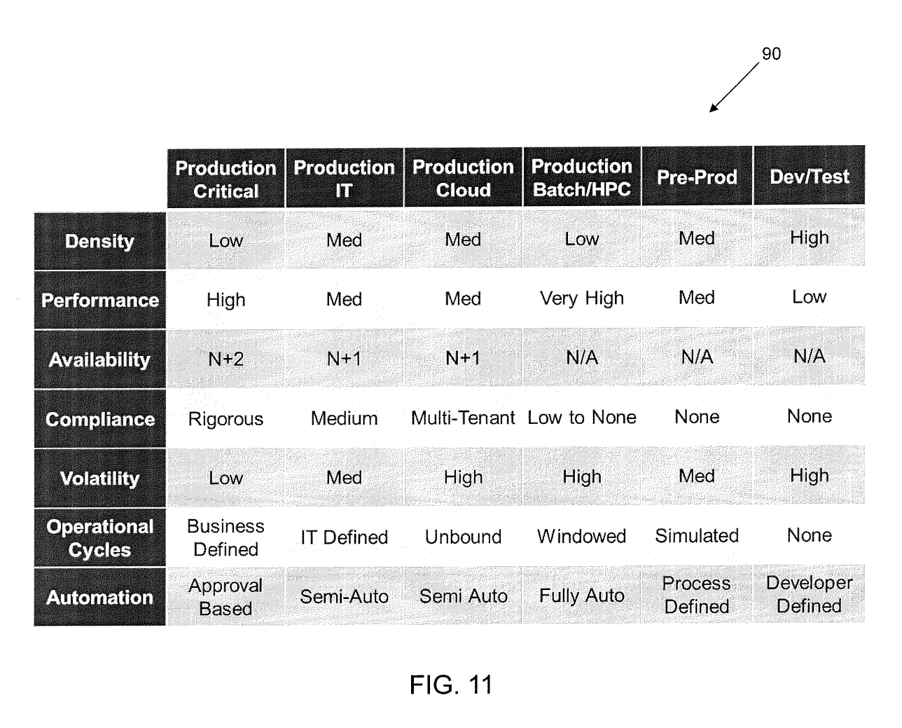

FIG. 11 illustrates an example of a policy chart 90 showing a high-level comparison of major policy areas across different types of hosting environments. For example a density policy 70 may dictate a low density is required for production critical environments, whereas a higher density is required in a development/testing environment. The policy chart 90 in FIG. 11 illustrates a high level summary of the aspects that can comprise typical policies 58. The policy chart 90 can be used to contrast the differences between various operational requirements and how they are reflected in the policies 58. For example, the policy chart 90 could be provided to a user/operator to enable the user to define the actual policy settings, which settings could then be rendered in a form, format, language, etc. that can be used by the capacity reservation system 20. This table is a high level view of the general areas of influence of a policy, and an actual policy contains much more specific criteria that affect each area.

### Capacity Reservation Process

In general, the capacity reservation system 20 should support the booking of capacity by providing the following capabilities: a) an ability to capture and/or receive demand profiles from the various sources described above; an ability to assess whether the demand will fit into the target environment 10, 24 at the future date it is scheduled to be deployed (taking into account trends as well as other confirmed bookings); and if the demand fits into the environment, the ability to “lock” the capacity so it cannot be usurped by another user/application (e.g., a subsequent or simultaneous booking).

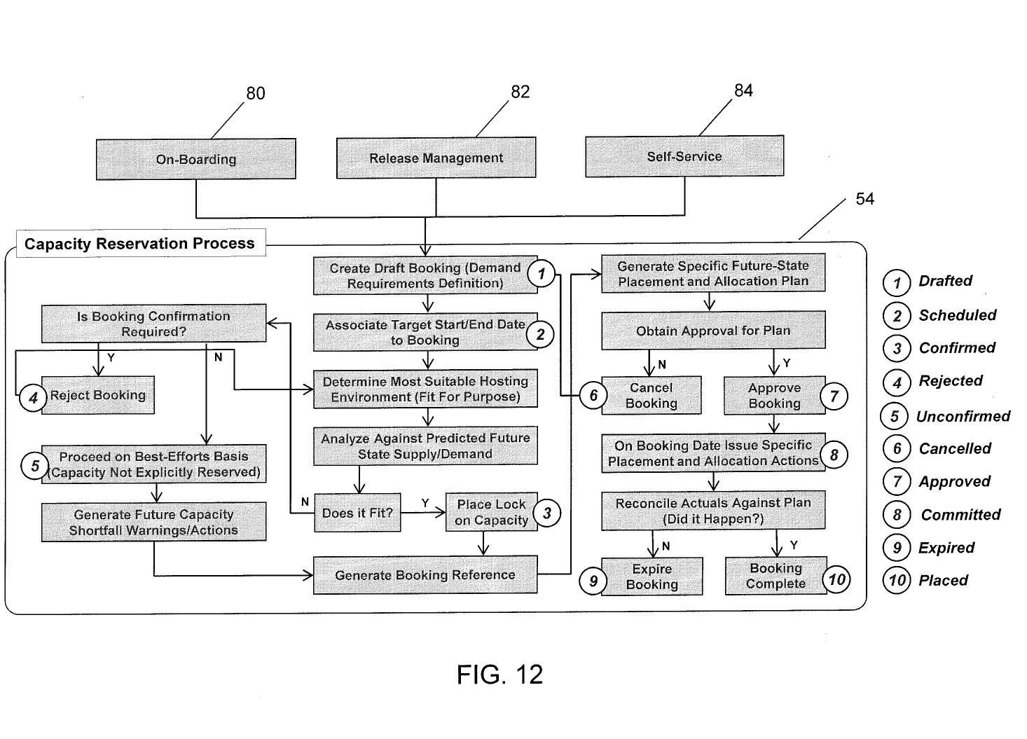

In order to model the future-state scenarios being assessed, the capacity reservation system 20 employs a bookings management process such as the one illustrated in FIG. 12, and the performance of predictive analytics 32. Predictive analytics 32 relate to modeling the workload trends based on historical patterns, modeling future workloads based on user-defined expectations, and future bookings. There are various methods for modeling workload trends such as linear regression. An example of modeling trends based on user-defined expectations is simply allowing the user to specify that future workload trend based on some expected activity (merger, sales campaign, etc.).

FIG. 12 illustrates an exemplary capacity reservation process 54 that may be applied after receiving demand inputs, e.g. from on-boarding 80, release management 82, and self-service 84 processes. Throughout the reservation process, a booking goes through several key states, as illustrated in FIG. 12.

In stage 1, a draft demand requirement is created or defined and captured to provide a demand requirements definition. At stage 2, the booking is scheduled, wherein a start date and optionally an end date) is associated with the booking. The most suitable hosting environment 10, 24 is then determined, i.e. the environment that is fit for the purpose of the workload 70. This can be determined using multiple criteria, including which environment is the least loaded, which is the most cost effective, which is optimally designed for this specific type of workload, etc.. The scheduled booking is also analyzed against predicted future state supply and demand to determine whether or not the demand fits the candidate hosting environment. If so, the next stage is stage 3, wherein the demand is confirmed as having been analyzed against the future-state models of the environment and has been deemed to fit. At this stage, the future state models are updated to incorporate the newly confirmed demand, so that this new demand has priority over future booking requests.

If the demand does not fit on the candidate host environment, the capacity reservation system 20 determines if a booking confirmation is required. Booking confirmations can be thought of as being similar to airline tickets being guaranteed, whereas booking confirmations not being required is analogous to going on “stand-by”. This difference may allow the cloud provider to provide different prices for the confirmed vs. unconfirmed bookings—much like airline ticket prices. If a booking confirmation is required, the booking is rejected at stage 4 and the process may return to make another determination of the most suitable hosting environment. When rejected, this indicates that the demand does not fit into the target environment. If a booking confirmation is not required, the capacity reservation system 20 may proceed to stage 5, the “unconfirmed” stage, wherein the demand does not fit, but the policy 58 does not require confirmations, and thus the demand will be still be entered into the future state model. This effectively means that the booking is granted, but that infrastructure managers will need to add capacity to the environment before the start date in order to not go offside from a capacity perspective.

Once a lock is placed on the capacity for the booked demand, or if the case where booking confirmation is not required, a booking reference is created and a specific further-state placement and allocation plan is generated. The placement relates to which physical hosts are to run the virtual machine workloads. The allocations refer to the resource configuration of the virtual machines—amount of memory, CPU, disk space, network, etc. The plan is presented, in order to obtain approval for the plan. If the booking passes the technical hurdles but the action plan to actually make it happen is rejected, the capacity reservation process 54 moves to the cancelled stage 6, meaning the system 20 failed to obtain business or ITSM process-level approval and the process 54 may return to stage 1. If the action plan to realize the booking is approved, the process 54 moves to the approved stage 7. Once the plan has been approved, and the booking date arrives, stage 8 is executed, which commits the booking. For example, the start date of the booking has arrived and the specific actions to realize it have been “locked and loaded” in the appropriate provisioning, orchestration and/or ticketing systems. The system 20 may reconcile what actual happens during stage 8 to determine if the plan was successfully executed. If not, the booking is expired in stage 9, e.g. wherein the action plan was committed but was not implemented, meaning the booking must be either re-created or rescheduled. If the booking went according to plan, stage 10 is executed, which completes the booking, indicating that the action plan was executed and the new instances are fully operational, signifying the fulfillment of the booking.

Accordingly, analogous to booking hotel capacity, the capacity reservation system 20 ensures that applications have the capacity they need, when they need it, without forcing infrastructure managers to wildly over-provision cloud environments to deal with uncertainty.

As indicated above, the capacity reservation process 54 should have the ability to: a) confirm that an anticipated demand can actually fit in to the target environment at the desired future point (or the target set/range of future dates being evaluated); and b) once the demand is formally booked into that environment, that other workloads 70 cannot “usurp” its capacity before it is actually deployed.

In the flowchart shown in FIG. 12, this is accomplished through the analysis against predicted future state supply and demand. As also described above, the analysis considers existing demands, new bookings, workload trends, capacity supply (and upcoming changes to it), and the control policies 58 governing the environments. Since application workloads 70 may carve out complex patterns over time, the confirmation of whether a given set of workloads 70 safely fit into the available capacity should be carefully considered. This confirmation may require looking at many dimensions of data, and assessing all the permutations and combinations of activity that can lead to operational risks.

### Efficiency Index

To leverage the output of the predictive analytics, an efficiency index may be utilized. For example, if a virtual or cloud environment has an efficiency index of 1.0, this means that supply and demand are perfectly matched, and based on policy 70, the workload levels and patterns stack up to exactly use the available capacity. An efficiency index of 0.75 in this example would mean that the workloads could be safely be hosted on three-quarters of the capacity currently deployed, signifying that the environment is over-provisioned and that there is space for new workloads (or, put another way, density can be safely increased). An efficiency index>1.0 in this example would then indicate that the environment is not only full, but is saturated (or, from a supply perspective, under-provisioned), and new capacity will need to be introduced (or demand removed) in order to alleviate the problem.

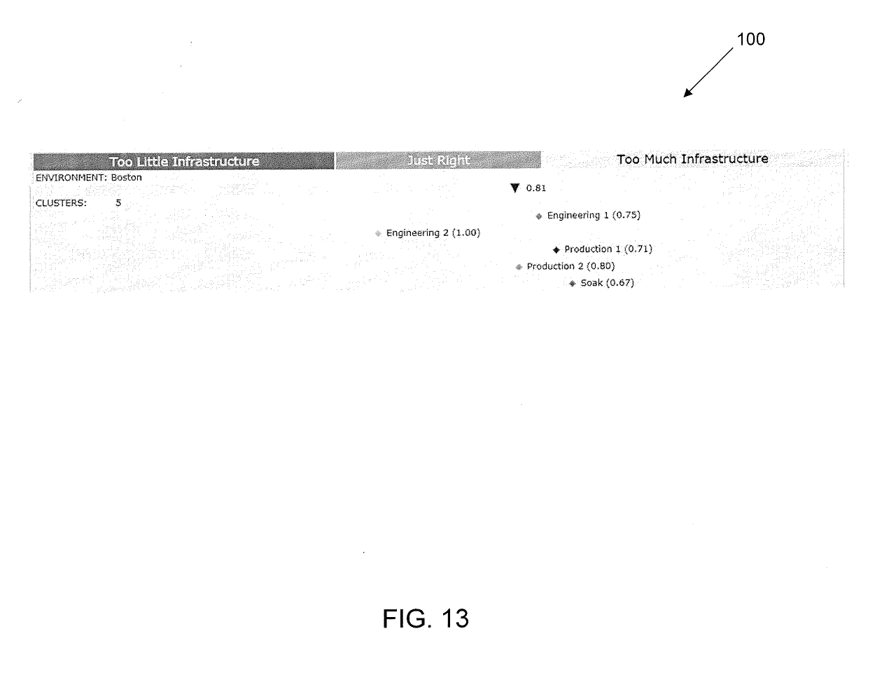

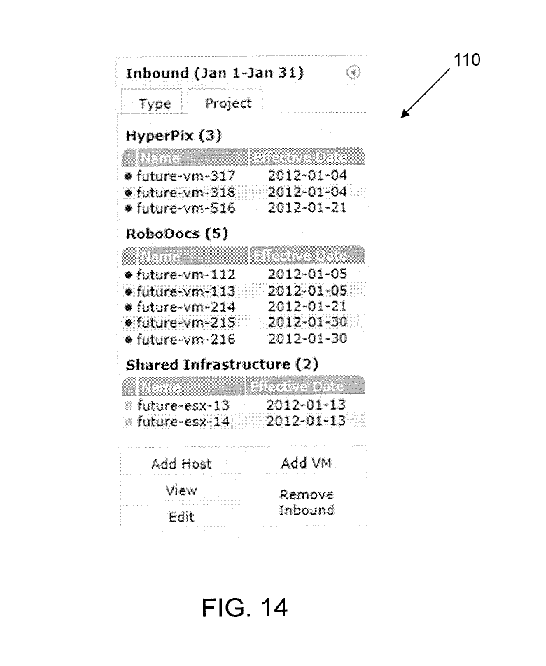

FIG. 13 provides a visualization of the efficiency index with a user interface 100 having a scale that shows environments that have “too little infrastructure”, those that are “just right” and those that have “too much infrastructure”. In the example shown in FIG. 14, four of the clusters (Engineering 1, Production 1, Production 2, and Soak) have excess capacity and efficiency indices less than one, and one cluster (Engineering 2) which is considered “full” or at capacity.

The capacity reservation system 20 utilizes system data related to the computing systems in a particular cluster and/or computing environment 10, 24 to quantify and visualize the efficiency and risks for a computing environment 10, 24. The system data may include resource utilization data and resource capacity data for conducting the analyses (as shown), and well as, for example, system configuration data and business related data (e.g., guest and host operating systems, guest workload uptime requirements, guest workload security level requirements, guest workload and host maintenance windows, guest workload balancing groups, guest workload high availability groups, etc.) The capacity reservation system 20 also obtains operational policies 58 to be considered when analyzing such efficiencies and risks. In evaluating the efficiencies and the risks, the capacity reservation system 20 may output at least one efficiency spectrum related to the computing environment 10, 24 which, as described below, depicts efficiencies and risks in the computing environment 10, 24 based on efficiency scores indicative of the efficiency index. It can be appreciated that the capacity reservation system 20 may also output recommended actions based on the efficiency scores.

Computing resources are consumed by workloads 70 and supplied by computing systems such as servers. Typically, the resources fall into four main areas: a) CPU—processing capacity, b) Memory—physical and virtual memory, c) Disk—disk storage and disk I/O bandwidth, and d) Network I/O—network interfaces and network I/O bandwidth.

The operational policies 58 help define the appropriate levels of resources required by a computing environment 10, 24 by considering factors such as: performance/service level requirements, workload growth assumptions (planned and trended), uptime-related requirements (hardware failures, disaster recovery, maintenance windows, etc.), and workload placement affinity and anti-affinity (data security, load balancing, failover, etc.). By combining the operational policies 58 with the actual resource utilization levels indicated in the resource utilization data, resource capacities indicated in the resource capacity data, system configuration data, and business attributes, the efficiencies and risks of a computing environment 10, 24 can be assessed.

The efficiency and risks of a computing environment can be quantified through an efficiency/risk score or index for each entity. The efficiency index for an entity is based on its utilization levels, allocated or available resources (e.g., determined from system data) and operational policies 58. At a high level, the efficiency index reflects whether the resources for the entity are appropriately provisioned, under-provisioned, or over-provisioned.

The efficiency index may be used to generate a spectrum (e.g. as shown in FIG. 13) and, optionally, recommended actions and/or other recommendations for addressing efficiency and/or risk issues identified via the computed efficiency indices. The system data can be obtained in order to analyze the resource utilization data and the resource capacity data. The operational policy 58 (or policies 58) may then be obtained and the system data and the operational policies 58 used to compute one or more efficiency indices according to the nature of the computing environment 10, 24 being evaluated.

### Efficiency Index and Future State Analysis

Combining the concept of an efficiency index with a future-state analysis, it is possible to compute the efficiency index of an environment at a future point in time based on trends, bookings and policies 58. This allows the capacity booking process 54 to be assessed using a more intuitive criterion, namely: if the introduction of new demand at a future date drives the efficiency index beyond 1.0 for that date (or the target set/range of future dates being evaluated), the booking will be rejected.

FIG. 14 illustrates a user interface 110 showing a bookings view for two new applications due to come online, as well as two new servers being added in the next defined period of time (30 days in this example).

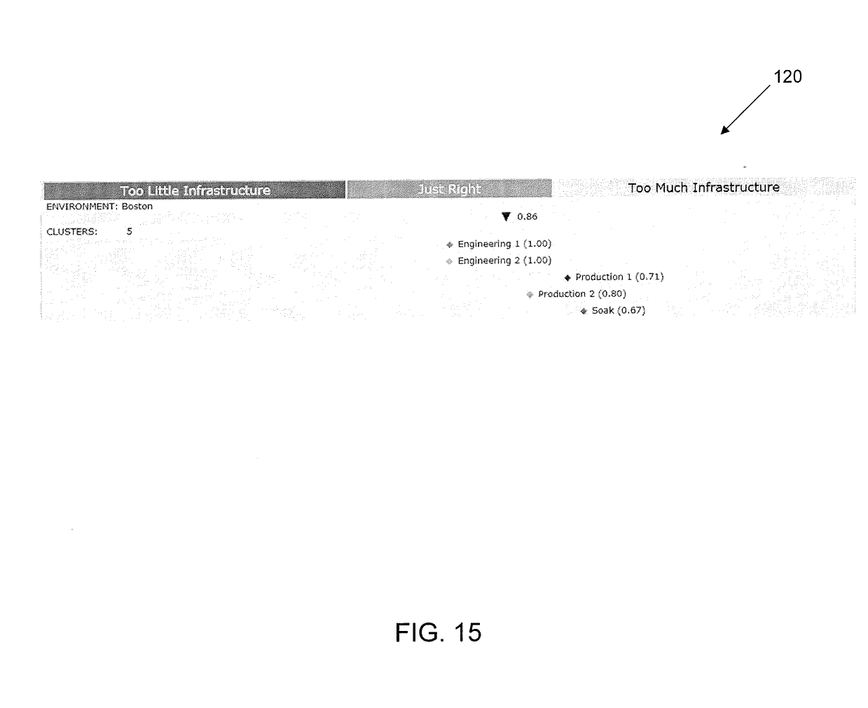

FIG. 15 provides a user interface 120 for showing a predictive analysis, in this example based on the environment illustrated in FIG. 13. The look-ahead for this environment accounts for all bookings, demand trends, and supply-side changes.

It can be appreciated that the impact of accurate capacity forecasting on both suppliers and consumers of capacity is quite significant. It not only allows supply-side infrastructure managers to “right-size” their infrastructure (saving significant cost), but gives demand-side consumers greater confidence that cloud infrastructure will meet their needs. Proper forward-looking analytics, based on agreed upon policies, allows infrastructure managers to give “official confirmation” to application groups that capacity has been reserved to meet their future needs.

This type of analysis also forms the basis for new and interesting models, some of which also parallel the hotel booking model. For example, by rewarding advanced bookings with lower costs, and penalizing last-minute bookings with higher costs, behavior can be shifted to promote better planning among users, reducing volatility and increasing efficiency. Just as walking into a hotel lobby and asking for a room at the last minute is both risky and expensive, last-minute cloud requests may eventually be viewed the same way. This is good for everyone, as it helps eliminate unplanned, reactionary operational models.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the capacity reservation system 20, cloud host 12, etc., or any component of or related to, or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A method for determining workload reservations in a virtual or cloud environment, the method comprising:
determining a workload to be booked and a time for the booking;
modeling a future demand in the environment;
modeling a future supply of hosts in the environment based on at least one of data obtained from the environment and planned changes to the environment;
executing a placement analysis using a future demand model, a future supply model, and at least one policy; and
using a result of the placement analysis in completing or rejecting a booking for the workload.

2. The method of claim 1, wherein the future supply comprises a consideration of at least one previously requested but not yet placed booking.

3. The method of claim 1, further comprising generating an efficiency index indicative of whether the workload can be placed without saturating the environment.

4. The method of claim 1, further comprising generating a placement plan to be used in generating the booking.

5. The method of claim 1, further comprising repeating the method for a plurality of future dates.

6. The method of claim 1, wherein the future demand model is generated based on at least one of pending workloads, existing workloads, and upcoming decommissioning of resources.

7. The method of claim 1, wherein the at least one policy is specific to the environment in which the workload is being placed.

8. The method of claim 1, further comprising reserving capacity for the workload upon approving the booking.

9. The method of claim 1, further comprising generating a future capacity warning after determining that the workload will not fit but that a booking confirmation is not required.

10. The method of claim 4, further comprising providing an output requesting approval for the placement plan.

11. The method of claim 1, wherein the future demand is determined from at least one demand model generated using any one or more of the following processes: on-boarding, release management, and self-service.

12. The method of claim 1, wherein the environment is a public cloud environment.

13. The method of claim 1, wherein the environment is a private cloud environment.

14. A computer readable storage medium comprising computer executable instructions for determining workload reservations in a virtual or cloud environment, the computer executable instructions comprising instructions for:
determining a workload to be booked and a time for the booking;
modeling a future demand in the environment;
modeling a future supply of hosts in the environment based on at least one of data obtained from the environment and planned changes to the environment;
executing a placement analysis using a future demand model, a future supply model, and at least one policy; and
using a result of the placement analysis in completing or rejecting a booking for the workload.

15. The computer readable storage medium of claim 14, wherein the future supply comprises a consideration of at least one previously requested but not yet placed booking.

16. The computer readable storage medium of claim 14, further comprising instructions for generating an efficiency index indicative of whether the workload can be placed without saturating the environment.

17. The computer readable storage medium of claim 14, further comprising instructions for generating a placement plan to be used in generating the booking.

18. The computer readable storage medium of claim 14, further comprising instructions for repeating the instructions for a plurality of future dates.

19. The computer readable storage medium of claim 14, wherein the future demand model is generated based on at least one of pending workloads, existing workloads, and upcoming decommissioning of resources.

20. A system for determining workload reservations in a virtual or cloud environment, the system comprising a processor and memory, the memory comprising computer executable instructions for operating the system by:
determining a workload to be booked and a time for the booking;
modeling a future demand in the environment;
modeling a future supply of hosts in the environment based on at least one of data obtained from the environment and planned changes to the environment;
executing a placement analysis using a future demand model, a future supply model, and at least one policy; and
using a result of the placement analysis in completing or rejecting a booking for the workload.
